(19) United States
(12) Patent Application Publication
(10) Pub. No.: US 2023/0007521 A1
(43) Pub. Date: Jan. 5, 2023

(54) TERMINAL AND MEASUREMENT REPORT TRANSMISSION METHOD

(71) Applicant: NTT DOCOMO, INC., Tokyo (JP)

(72) Inventors: Hideaki Takahashi, Tokyo (JP); Tianyang Min, Tokyo (JP)

(73) Assignee: NTT DOCOMO, INC., Tokyo (JP)

(21) Appl. No.: 17/756,870

(22) PCT Filed: Dec. 6, 2019
(86) PCT No.: PCT/JP2019/047851

§ 371 Date: Jun. 3, 2022

(51) Int. Cl. H04W 24/10; H04W 16/28

(52) U.S. Cl. CPC H04W 24/10; H04W 16/28

(57) ABSTRACT

A terminal includes: a transmitting unit configured to transmit, to a radio access network, a measurement report including reception qualities regarding cells including a serving cell and neighboring cells; and a control unit configured to determine whether a trigger condition used for determining whether to perform a procedure of transmitting the measurement report is satisfied. The trigger condition includes at least a condition regarding individual beams from the neighboring cells.

### TECHNICAL FIELD

The present invention relates to a terminal for transmitting, to a radio access network, a measurement report including reception quality regarding cells including a serving cell and a neighboring cell, and a measurement report transmission method.

### BACKGROUND ART

The 3rd Generation Partnership Project (3GPP) specifies Long Term Evolution (LTE) and specifies LTE-Advanced (hereinafter referred to as LTE including LTE-Advanced) and 5th generation mobile communication system (called 5G, New Radio (NR), or Next Generation (NG)) for the purpose of further increasing the speed of LTE. Furthermore, the specifications for mobile communication systems after 5G are also being advanced (sometimes referred to as 6G or beyond 5G, but not limited to these names).

In NR, a terminal (UE) can transmit, to a radio access network (NG RAN), a measurement report including reception quality measurement results (RSRP (Reference Signal Received Power), RSRQ (Reference Signal Received Quality), SINR (Signal-to-Interference plus Noise Ratio), or the like) regarding a serving cell (cell in a connected state (RRC Connected) in a radio resource control (RRC) layer) and neighboring cells formed in the vicinity of the serving cell (see Non Patent Literature 1).

### CITATION LIST

### Non Patent Literature

Non Patent Literature 1: 3GPP TS38.331 V15.7.0 3rd Generation Partnership Project; Technical Specification Group Radio Access Network; NR; Radio Resource Control (RRC); Protocol specification (Release 15), 3GPP, September 2019

### SUMMARY OF INVENTION

In the technology described above, the procedure (measurement reporting) of transmitting the measurement report is started when the entering condition is satisfied. The entering condition includes a condition defined for reception quality in cell units.

By the way, in recent years, a technology for radiating one or more highly directional beams from each cell has been proposed (beam forming, etc.). However, such a technology is not assumed in the entering conditions defined for reception quality in cell units. Under such circumstances, the inventors of the present invention, as a result of earnest studies, have found that, in view of the above-mentioned situation, uplink interference may increase with frequent transmission of measurement reports.

According to one aspect of the present disclosure, a terminal includes: a transmitting unit configured to transmit, to a radio access network, a measurement report including reception qualities regarding cells including a serving cell and neighboring cells; and a control unit configured to determine whether an entering condition used for determining whether to perform a procedure of transmitting the measurement report is satisfied, wherein the entering condition includes at least a condition regarding individual beams from the cells.

According to one aspect of the present disclosure, a measurement report transmission method includes: a step of transmitting, from a terminal to a radio access network, a measurement report including reception qualities regarding cells including a serving cell and neighboring cells; and a step of determining, by the terminal, whether an entering condition used for determining whether to perform a procedure of transmitting the measurement report is satisfied, wherein the entering condition includes at least a condition regarding individual beams from the cells.

### BRIEF DESCRIPTION OF DRAWINGS

FIG. 1 is an overall schematic configuration diagram of a radio communication system 10.

FIG. 2 is a diagram for explaining an application scene according to an embodiment.

FIG. 3 is a diagram illustrating a UE 200 according to an embodiment.

FIG. 4 is a diagram illustrating an example of MeasConfig according to an embodiment.

FIG. 5 is a diagram illustrating an example of MeasResults according to an embodiment.

FIG. 6 is a sequence diagram illustrating a measurement report transmission method according to an embodiment.

FIG. 7 is a flow diagram illustrating an operation of a UE 200 according to an embodiment.

FIG. 8 is a diagram illustrating an example of a hardware configuration of a UE 200 according to an embodiment.

### DESCRIPTION OF EMBODIMENTS

Hereinafter, embodiments will be described with reference to the drawings. It should be noted that the same functions or configurations are denoted by the same or similar reference numerals, and a description thereof will be omitted as appropriate.

### Embodiment

(1) Overall Schematic Configuration of Radio Communication System

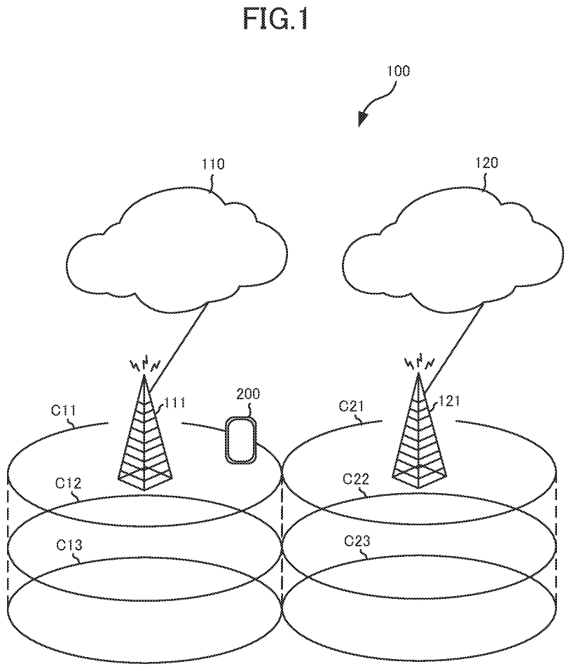

FIG. 1 is an overall schematic configuration diagram of a radio communication system 100 according to an embodiment. The radio communication system 100 is a radio communication system in accordance with Long Term Evolution (LTE) and 5G New Radio (NR). It should be noted that TEE may be called 4G, and NR may be called 5G. LTE and NR may be interpreted as a radio access technology (RAT). In an embodiment, LTE may be called a first radio access technology and NR may be called a second radio access technology. NR may be considered to include radio access technologies of 50 and later.

The radio communication system 100 includes an Evolved Universal Terrestrial Radio Access Network 110 (hereinafter, E-UTRAN 110) and a Next Generation-Radio Access Network 120 (hereinafter, NG RAN 120). Also, the radio communication system 100 includes a terminal 200.

The E-UTRAN 110 includes an eNB 111 that is a radio base station in accordance with LTE. The eNB 111 has one or more cells (here, cells C11, C12, and C13). The eNB 111 may have one cell.

The NG RAN 120 includes a gNB 121 that is a radio base station in accordance with 5G (NR). The gNB 121 has one or more cells (here, cells C21, C22, and C23). The gNB 121 may have one cell.

The term “cell” may be used to refer to the function of the eNB 111 or the gNB 121, that is, the function of communicating with the terminal 200. The term “cell” may be used to refer to the coverage area of the eNB 111 or gNB 121. Each cell may be distinguished by the frequency used in each cell. The E-UTRAN 110 and the NO RAN 120 (which may be the eNB 111 or the gNB 121) may be simply called a radio access network or may be called a network.

The eNB 1111, the gNB 121 and the terminal 200 may correspond to carrier aggregation (CA) using a plurality of component carriers (CC), and may correspond to dual connectivity (DC) in which component carriers are simultaneously transmitted between the plurality of NG-RAN nodes and the terminal 200.

The eNB 111, the gNB 121, and the terminal 200 perform radio communication via a radio bearer. The radio bearer may include an SRB Signaling Radio Bearer (SRB) and a DRB Data Radio Bearer (DRB).

The terminal 200 is not particularly limited, but may be called a “mobile station (MS)” or a “user equipment (UE)”. Hereinafter, the terminal 200 will be referred to as a UE 200. The UE 200 may be an unmanned aerial vehicle (UAV). The serving cell may be called a PCell (Primary Cell) or a PSCell (Primary Secondary Cell).

(2) Application Scene

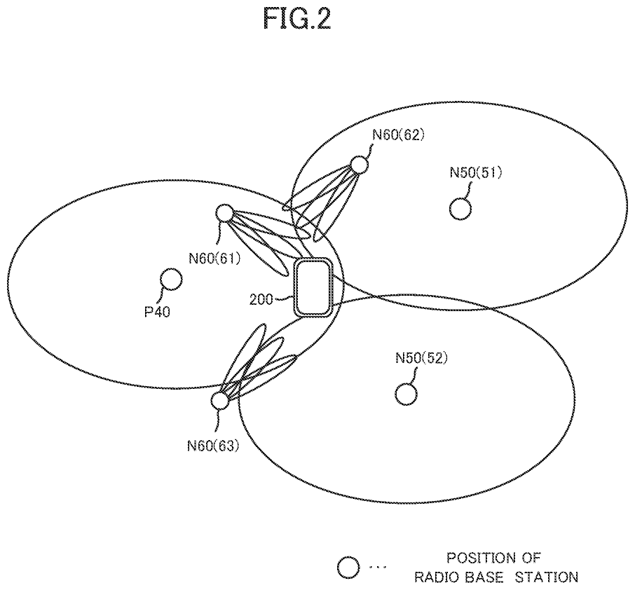

FIG. 2 is a diagram for explaining an application scene according to an embodiment. Here, a case in which the serving cell of the UE 200 is a cell P40 will be exemplified. For example, neighboring cells formed in the vicinity of the serving cell may include a cell N50 (here, cells N51 and N52) and a cell N60 (here, cells N61, N62, and N63).

The cell P40 may be a cell belonging to the E-UTRAN 110 or a cell belonging to the NG RAN 120. For example, the cell N50 may be a cell belonging to the E-UTRAN 110, and the cell N60 may be a cell belonging to the NG RAN 120. In the following, cells belonging to the E-UTRAN 110 may be referred to as EUTRA cells, and cells belonging to the NG RAN 120 may be referred to as NR cells.

Here, the cells belonging to the NG RAN 120 (for example, the cells N61, N62, and N63) may be configured to output one or more beams (three beams in FIG. 2) having strong directivity. The beams having strong directivity are realized by a large number (for example, 128 at maximum) of antennas. Such a technology may be called Massive MIMO (Multi Input Multi Output) technology.

Under such a background, the UE 200 transmits, to the radio access network (here, cell P40), a measurement report including reception quality regarding the cells including the serving cell (here, cell P40) and the neighboring cells (here, cells N51, N52, N61, N62, and N63) (hereinafter, measurement report). The procedure in which the UE 200 transmits the measurement report may be called measurement reporting. The reception quality regarding the cell may include the reception quality of the beam from the cell, and may include the reception quality of the cell based on the beam from the cell.

The UE 200 may periodically perform measurement reporting. The UE 200 may perform measurement reporting for every event. An entering condition for starting measurement reporting and a leaving condition for ending measurement reporting may be defined for each event. The existing events may include the following events (see 3GPP TS38.331 V15.7.0 Chapters 5.5.4.2 to 5.5.4.7 “Event A1” to “Event A6”).

(i) Event A1

Event A1 is an event in which the reception quality of the serving cell becomes better than a threshold. For example, the entering condition is Ms·Hys>Thresh, and the leaving condition is Ms+Hys<Thresh.

Here, Ms is the reception quality of the serving cell, Hys is the hysteresis parameter, and Thresh is the threshold.

(ii) Event A2

Event A2 is an event in which the reception quality of the serving cell becomes worse than the threshold. For example, the entering condition is Ms+Hys<Thresh, and the leaving condition is Ms—Hys>Thresh.

Here, Ms is the reception quality of the serving cell, Hys is the hysteresis parameter, and Thresh is the threshold.

(iii) Event A3

Event A3 is an event in which the reception quality of the neighboring cell becomes better than the reception quality of the serving by an offset. For example, the entering condition is Mn+Ofn+Ocn−Hys>Mp+Ofp+Ocp+Off, and the leaving condition is Mn+Ofn+Ocn+Hys<Mp+Ofp+Ocp+Off.

Here, Mn is the reception quality of the neighboring cell, Ofn is the offset unique to the measurement target, and Ocn is the offset unique to the cell. Mp is the reception quality of the serving cell, Ofp is the offset unique to the measurement target, and Ocp is the offset unique to the cell. Hys is the hysteresis parameter, and Off is the parameter used in Event A3.

(iv) Event A4

Event A4 is an event in which the reception quality of the neighboring cell becomes better than a threshold. For example, the entering condition is Mn+Ofn+Ocn−Hys>Thresh, and the leaving condition is Mn+Ofn+Ocn+Hys<Thresh.

Here, Mn is the reception quality of the neighboring cell, Ofn is the offset unique to the measurement target, and Ocn is the offset unique to the cell. Hys is the hysteresis parameter and Thresh is the threshold.

(v) Event A5

Event A5 is an event in which the reception quality of the serving cell becomes worse than the threshold and the reception quality of the neighboring cells becomes better than the threshold. For example, the entering condition is Mp+Hys<Thresh1 and Mn+Ofn+Ocn−Hys>Thresh2, and the leaving condition is Mp−Hys>Thresh1 and Mn+Ofn+Ocn+Hys<Thresh2.

Here, Ms is the reception quality of the serving cell, Hys is the hysteresis parameter, and Thresh1 is the threshold. Mn is the reception quality of the neighboring cell, Ofn is the offset unique to the measurement target, and Ocn is the offset unique to the cell. Hys is the hysteresis parameter and Thresh2 is the threshold.

(vi) Event A6

Event A6 is an event in which the reception quality of the neighboring cells becomes better than the reception quality of the SCell (Secondary Cell) by an offset. For example, the entering condition is Mn+Ocn−Hys>Ms+Ocs+Off, and the leaving condition is Mn+Ocn+Hys<Ms+Ocs+Off.

Here, Mn is the reception quality of the neighboring cell, and Ocn is the offset unique to the cell. Ms is the reception quality of the SCell, and Ocs is the offset unique to the cell. Hys is the hysteresis parameter, and Off is the parameter used in Event A6.

As described above, in the existing event, the entering condition and the leaving condition are only defined for the reception quality in cell units. On the contrary, in an embodiment, a trigger condition used for determining whether to perform measurement reporting may include at least a condition regarding individual beams from neighboring cells. Specifically, the trigger condition (condition regarding the individual beams) used for determining whether to start measurement reporting may include a condition in which the total number of beams observed as beams from the neighboring cells exceeds a threshold. The threshold that is compared with the total number of beams may be called numOfTriggerBeam. When counting the number of SS/PBCH blocks (Synchronization Signal/Physical Broadcast Channel Blocks) as the number of beams, the above-described threshold may be called numOfTriggerSSB. When counting the number of CSIs (Channel State Information)-RS (Reference Signals) as the number of beams, the above-described threshold may be called numOfTriggerCSI−RS.

The threshold (for example, numOfTriggerBeam) may be configured for all the neighboring cells. For example, as illustrated in FIG. 2, in the case in which cells N61, N62, and N63 are provided as the neighboring cells, if “9” is configured as the threshold, the UE 200 may start measurement reporting when all the beams (nine beams) from the cells N61, N62, and N63 are observed. Alternatively, in the case in which cells N61, N62, and N63 are provided as the neighboring cells, if “6” is configured as the threshold, the UE 200 may start measurement reporting when the total number of beams observed as the beams from the cells N61, N62, and N63 is “6” or more.

The threshold (for example, numOfTriggerBeam) may be configured for one neighboring cell. For example, as illustrated in FIG. 2, in the case in which the cell N61 is targeted as the neighboring cell and “3” is configured as the threshold, the UE 200 may start measurement reporting when all the beams (three beams) from the cell N61 are observed. Alternatively, in the case in which the cell N61 is targeted as the neighboring cell and “2” is configured as the threshold, the UE 200 may start measurement reporting when the total number of beams observed as the beams from the cell N61 is “2” or more.

The processing of comparing the total number of beams with the threshold may be performed for the neighboring cells triggered by the above-described events (for example, Events A3, A4, A5, and AC).

The trigger condition may include a condition that the number of neighboring cells observed by the UE 200 exceeds the threshold. The threshold that is compared with the number of neighboring cells may be called numOfTriggerCell. The UE 200 may start measurement reporting if the number of neighboring cells observed by the UE 200 exceeds the threshold (for example, numOfTriggerCell). numOfTriggerCell may be used together with numOfTriggerBeam.

The trigger condition may include a condition that a certain time has passed since the measurement report was transmitted. The transmission of the measurement report may be prohibited until a timer activated by the transmission of the measurement report expires. Such a timer may be called ULInterferenceProhibitTimer. ULInterferenceProhibitTimer may be used together with numOfTriggerBeam.

(3) Functional Block Configuration of Terminal

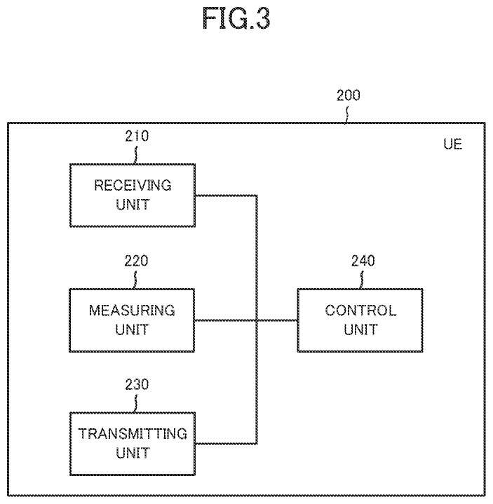

FIG. 3 is a diagram illustrating a functional block configuration of a UE 200 according to an embodiment. As illustrated in FIG. 3, the UE 200 includes a receiving unit 210, a measuring unit 220, a transmitting unit 230, and a control unit 240.

The receiving unit 210 receives various types of information from a network (for example, eNB 111 or gNB 121). In an embodiment, the receiving unit 210 receives a configuration information element (hereinafter, MeasConfig) used for performing measurement reporting from a network (for example, a serving cell).

The network can configure measurement reporting that reports measurement results (hereinafter, measurement results) for each SS/PBCH block to the UE. The network may configure measurement reporting that reports measurement results for each SS/PBCH Block(s) to the UE, and may configure measurement reporting that reports measurement results for each cell based on SS/PBCH Block(s) to the UE. The network may configure measurement reporting that reports measurement results for each CSI-RS resource to the UE, and may configure measurement reporting that reports measurement results for each cell based on CSI-RS resource to the LIE.

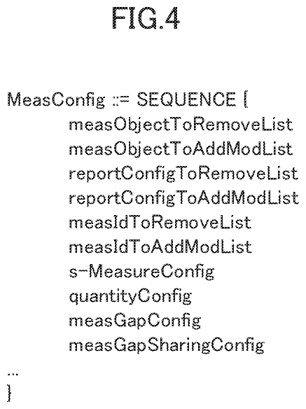

For example, as illustrated in FIG. 4, MeasConfig (configuration information element) includes measObjectToRemoveList, measObjectToAddModList, reportConfigToRemoveList, reportConfigToAddModList, measIdToRemoveList, measIdToAddModList, s-MeasureConfig, quantityConfig, measGapConfig, measGapSharingConfig, and the like (see 3GPP TS38.331 V15.7.0, chapter 6.3.2 “Radio resource control information elements” “MeasConfig”).

measObjectToRemoveList is a list of measObject to be removed, and measObjectToAddModList is a list of measObject to be added or modified. measObject is a list of objects on which the UE 200 has to perform measurement. measObject may be specified by frequency.

reportConfigToRemoveList is a list of reportConfig to be removed, and reportConfigToAddModList is a list of reportConfig to be added or modified. reportConfig is a report configuration for each measObject. The report configuration may include a condition for transmitting a measurement report, an RS (Reference Signal) type used by the UE 200, a report format, and the like. The condition for transmitting the measurement report may include the above-described event types and the parameters (threshold, hysteresis, offset, etc.) that define the above-described conditions for each event. The RS type may be an information element that specifies SS/PBCH Block or CSI-RS.

In an embodiment, the threshold (for example, numOfTriggerBeam) that is compared with the number of beams may be included in reportConfig. The threshold (for example, numOfTriggerCell) that is compared with the number of neighboring cells m ay be included in reportConfig. The value set in the timer (for example, ULInterferenceProhibitTimer) activated by the transmission of the measurement report may be included in reportConfig.

measIdToRemoveList is a list of measIds to be removed, and measIdToAddModList is a list of measIds to be added or modified. measId is an identifier that links measObject and reportConfig.

s-MeasureConfig is a threshold of a serving cell (PCell/PSCell) for controlling whether the UE 200 performs the measurement of non-serving cells (intra-frequency, inter-frequency and inter-RAT neighboring cells). quantityConfig is an information element that defines the configuration for which measurements has to be filtered. measGapConfig and measGapSharingConfig are information elements used by the UE 200 to perform measurements.

The measuring unit 220 measures reception quality of cells including the serving cell and the neighboring cells. For example, the measuring unit 220 measures the reception quality of the RS (Reference Signal) received from the EUTRA cell. The measuring unit 220 measures the reception quality of the beam observed, as the beam from the NR cell. The reception quality may be RSRP, RSRQ, or SINR. The reception quality of the NR cell may be an average value of the reception qualities of the observed beams.

The transmitting unit 230 transmits various types of information to the network (eNB 111 or gNB 121). In an embodiment, the transmitting unit 230 transmits the measurement report to the network (for example, the serving cell).

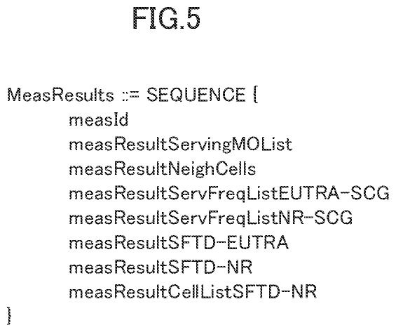

For example, the measurement report includes measResults (measurement results) illustrated in FIG. 5. Specifically, MeasResults includes measId, measResultServingMOList, measResultNeighCells, measResultServFreqListEUTRA-SCG, measResultServFreqListNR-SCG, measResultSFTD-EUTRA, measResultSFTD-NR, and measResultCellListSFTD-NR (see TS38.331 V15.7.0, chapter 6.3.2, the column “measResults” of “Radio resource control information elements”).

measId is the identifier of the report for which the report was made. measResultServingMOList includes the measurement results of SpCell, SCell, and best neighboring cell included in measObject. measResultNeighCells includes the EUTRAcell measurement result and the NR cell measurement result. measResultServFreqListEUTRA-SCG includes the measurement result of the serving frequency of SCG (Secondary Cell Group) of EUTRA. measResultServFreqListNR-SCG includes the measurement result of the NR SCG serving frequency.

measResultSFTD-EUTRA includes the result of SFTD measurement (SFN and Frame timing difference measurement) between the PCell and the EUTRA cell of the NR in the NR-E-UTRA Dual Connectivity.

measResultSFTD-NR includes the result of SFTD measurement between the NR PCell and the NR PSCell in the NR-NR Dual Connectivity.

measResultCellListSFTD-NR includes the result of SFTD measurement between the PCell of the NR and the neighboring cells of the NR.

The control unit 240 controls the operation of the UE 200. For example, the control unit 240 may periodically perform measurement reporting. The control unit 240 may perform measurement reporting for each event. An entering condition for starting measurement reporting and a leaving condition for ending measurement reporting may be defined for each event.

Specifically, the control unit 240 starts measurement reporting if the trigger condition used for determining whether to start measurement reporting is satisfied. The above-described event-specific entering conditions may be considered to be part of the trigger condition. The control unit 240 ends measurement reporting if the trigger condition used for determining whether to end measurement reporting is satisfied. The above-described leaving condition for each event may be considered to be part of the trigger condition.

Here, the trigger condition may include at least a condition regarding individual beams from neighboring cells. Specifically, the condition regarding the individual beams may include a condition that the total number of beams observed as the beams from the neighboring cells exceeds a threshold (for example, numOfTriggerBeam).

The trigger condition may include a condition that the number of neighboring cells observed by the UE 200 exceeds a threshold (for example, numOfTriggerCell). numOfTriggerBeam and numOfTriggerCell may be used together.

The trigger condition may include a condition that the timer (ULInterferenceProhibitTimer) started by the transmission of the measurement report expires. In other words, the transmission of the measurement report may be prohibited until the timer expires.

(4) Measurement Report Transmission Method

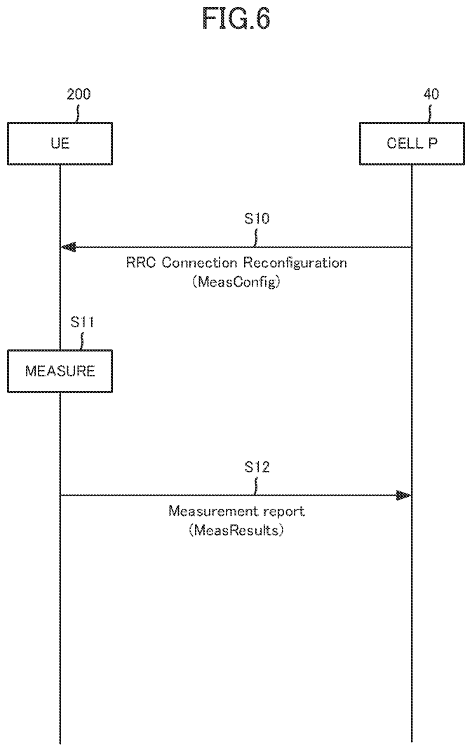

First, the measurement report transmission method will be described based on the relationship between the UE 200 and the network. FIG. 6 is a sequence diagram illustrating a measurement report transmission method according to an embodiment.

As illustrated in FIG. 6, in step S10, the UE 200 receives an RRC Connection Reconfiguration from a network (here, the cell P40). The cell P40 is a serving cell. The RRC Connection Reconfiguration is a message transmitted when an RRC connection is reconfigured. As described above, the RRC Connection Reconfiguration includes MeasConfig (information element) illustrated in FIG. 4.

In step S11, the UE 200 performs measurement based on MeasConfig. Specifically, the UE 200 measures the reception quality regarding cells including a serving cell and neighboring cells. The neighboring cell may include a EUTRAcell or an NR cell. The reception quality may be RSRP, RSRQ, or SINR. The reception quality of the NR cell may be an average value of the reception qualities of the observed beams.

In step S12, the UE 200 transmits a measurement report. The measurement report includes MeasResults illustrated in FIG. 5. MeasResults may include the measurement results of SS/PBCH Block(s), or may include the measurement results of each cell based on SS/PBCH Block(s). MeasResults may include the measurement results for each CSI-RS resource, or may include the measurement results for each cell based on the CSI-RS resource.

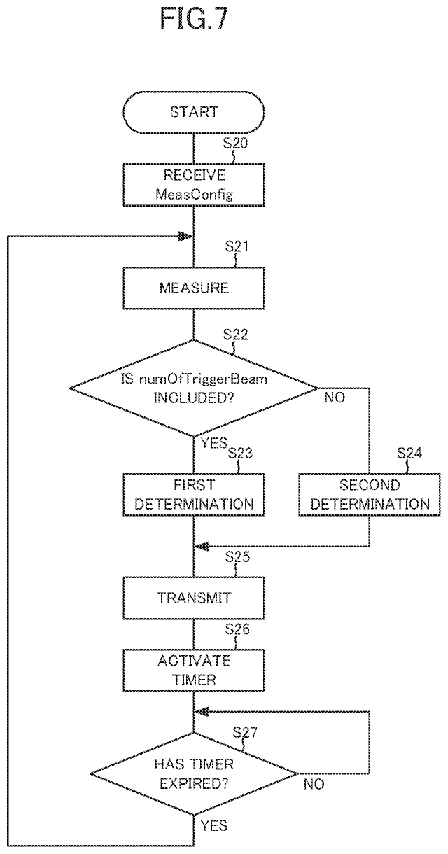

Second, the measurement report transmission method will be described based on the operation of the UE 200. FIG. 7 is a flow diagram illustrating the measurement report transmission method according to an embodiment.

As illustrated in FIG. 7, in step S20, the UE 200 receives MeasConfig. For example, MeasConfig is included in an RRC Connection Reconfiguration.

In step S21, the UE 200 performs measurement based on MeasConfig. Since the operation of step S21 is the same as that of step S11, a description thereof will be omitted.

In step S22, the UE 200 determines whether numOfTriggerBeam is included in MeasConfig. If the determination result is YES, the UE 200 performs the processing of step S23. If the determination result is NO, the UE 200 performs the processing of step S24.

In step S23, the UE 200 determines whether the trigger condition for starting measurement reporting is satisfied. In step S23, the trigger condition may include a condition that the number of neighboring cells observed by the UE 200 exceeds a threshold (for example, numOfTriggerCell). The trigger condition may include the above-described entering condition for each event.

Here, the description will be continued on the assumption that the trigger condition is satisfied in step S23. If the trigger condition is not satisfied, the measurement of the reception quality regarding the serving cell and the neighboring cells is continued. The determination in step S23 may be performed according to the detection of a new cell. The determination in step S23 may be periodically performed. If the leaving condition is satisfied, the UE 200 ends the measurement reporting.

In step S24, the UE 200 determines whether the trigger condition for starting the measurement report is satisfied. In step S23, the trigger condition may not include a condition that the number of neighboring cells observed by the UE 200 exceeds a threshold (for example, numOfTriggerCell). The trigger condition may include the above-described entering condition for each event.

Here, the description will be continued on the assumption that the trigger condition is satisfied in step S24. If the trigger condition is not satisfied, the measurement of the reception quality regarding the serving cell and the neighboring cells is continued. The determination in step S24 may be performed according to the detection of a new cell. The determination in step S24 may be periodically performed. If the leaving condition is satisfied, the UE 200 ends the measurement reporting.

In step S25, the UE 200 transmits a measurement report. Since the operation of step S25 is the same as that of step S12, a description thereof will be omitted.

In step S26, the UE 200 starts a timer (for example, ULInterferenceProhibitTimer).

In step S27, the UE 200 determines whether the timer has expired. If the determination result is YES, the UE 200 returns to the processing of step S21. If the determination result is YES, the UE 200 waits until the timer expires.

(5) Operation and Effect

In an embodiment, a trigger condition used for determining whether to perform measurement reporting may include at least a condition regarding individual beams from neighboring cells. The condition regarding the individual beams may include a condition that the total number of beams observed as the beams from the neighboring cells exceeds the threshold (for example, numOfTriggerBeam). According to such a configuration, the possibility of starting measurement reporting only by observing part of the beams from the neighboring cells (NR cells) is mitigated, and the situation that frequent transmission of measurement reports for NR cells is suppressed.

Here, in the case in which the UE 200 is an unmanned aerial vehicle (UAV), the visibility of the propagation environment is good, and the beam from the NR cell is easily observed. Thus, the embodiments are useful in the case in which the UE 200 is an unmanned aerial vehicle (UAV).

However, even if the UE 200 is not an unmanned aerial vehicle (UAV), the same situation may occur in the case in which the UE 200 exists on a higher floor, and therefore the UE 200 is not limited to the unmanned aerial vehicle (UAV).

### [Modification 1]

Hereinafter, Modification 1 of the embodiment will be described. Differences from the embodiment will be described below.

In the embodiment, the case in which the conditions for individual beams from neighboring cells are configured separately from the entry conditions for each event has been described. On the other hand, in Modification 1, the case in which the entry condition for each event includes a condition regarding individual beams from neighboring cells is exemplified. Specifically, the following new events may be introduced.

(i) Event X1

For example, the entering condition of Event X1 may be defined as: the number of neighbour beams whose qualities become offset better than PCell/PSCell exceeds the number X1.

That is, the entering condition of Event X1 includes a condition that, regarding the beams observed as the beams from the neighboring cells, the number of neighbour beams having reception quality that is better than the reception quality of the serving cell (PCell or PSCell) by the offset exceeds the threshold (the number X1).

Here, the parameters (offset, threshold) defining the entering condition may be included in the above-described reportConfig.

(ii) Event Y1

For example, the entering condition of Event Y1 may be defined as: the number of neighbour beams whose qualities become better than absolute threshold exceeds the number Y1.

That is, the entering condition of Event Y1 includes a condition that, regarding the beams observed as the beams from the neighboring cells, the number of neighbour beams having better reception quality than the absolute threshold exceeds the threshold (the number Y1).

Here, the parameters (absolute threshold, threshold) defining the entering condition may be included in the above-described reportConfig.

(iii) Event Z1

For example, the entry condition of Event Z1 may be defined as: the PCell/PSCell becomes worse than absolute threshold1 AND the number of neighbour beams whose qualities become better than another absolute threshold2 exceeds the number Z1.

That is, the entering condition of Event Z1 includes a condition that the reception quality of the serving cell (PCell/PSCell) becomes worse than the absolute threshold (threshold1), and regarding the beams observed as the beams from the neighboring cells, the number of beams (the number of neighbour beams) having reception quality better than the absolute threshold (another absolute threshold2) exceeds the threshold (the number Z).

As described above, in Event Z1, the trigger condition includes, in addition to the condition regarding the beams observed as the beams from the neighboring cells, the condition that the reception quality of the serving cell deteriorates below the absolute threshold.

Here, the parameters (absolute threshold, threshold) defining the entering condition may be included in the above-described reportConfig.

According to such a configuration, similar to the embodiment, it is possible to suppress the situation in which the measurement report regarding the NR cell is frequently transmitted.

### [Modification 2]

Hereinafter, Modification 2 of the embodiment will be described. Differences from the embodiment will be described below.

In the embodiment, the case in which the conditions for individual beams from neighboring cells are configured separately from the entry conditions for each event has been described. On the other hand, in Modification 2, the case in which the entry condition for each event includes a condition regarding individual beams from neighboring cells is exemplified. Specifically, the conditions regarding individual beams in the above-described Events A3 to A5 are as follows. The condition regarding the individual beams may include a condition that the reception quality of the beam is better than the absolute threshold. Further, the trigger condition (entering condition) includes a condition defined for reception quality of at least one of the serving cell and the neighboring cell.

(i) Event A3*

The entry condition of Event A3* may be defined as: Neighbour becomes amount of offset better than PCell/PSCell, and each beam of Neighbour is better than absolute threshold X2.

That is, a condition that each of the beams observed as the beams from the neighboring cells (each beam of Neighbour) is better than an absolute threshold (absolute thresholdX2) is added to the above-described entering condition of Event A3.

Here, the parameters (absolute threshold) defining the entering condition may be included in the above-described reportConfig.

(ii) Event A4*

The entry condition of Event A4 may be defined as: Neighbour becomes better than absolute threshold, and each beam of Neighbour is better than another absolute thresholdY2.

That is, a condition that each of the beams observed as the beams from the neighboring cells (each beam of Neighbour) is better than an absolute threshold (another absolute thresholdY2) is added to the above-described entering condition of Event A4.

Here, the parameters (absolute threshold) defining the entering condition may be included in the above-described reportConfig.

(iii) Event A5*

The entry condition of Event A5* may be defined as: PCell/PSCell becomes worse than absolute threshold1 AND Neighbour becomes better than another absolute threshold2, AND each beam of Neighbour is better than another absolute threshold Z2.

That is, a condition that each of the beams observed as the beams from the neighboring cells (each beam of Neighbour) is better than an absolute threshold (another absolute thresholdZ2) is added to the above-described entering condition of Event A5.

Here, the parameters (absolute threshold) defining the entering condition may be included in the above-described reportConfig.

According to such a configuration, similar to the embodiment, it is possible to suppress the situation in which the measurement report regarding the NR cell is frequently transmitted.

Furthermore, Modification 2 includes a condition that the reception quality of the beam is better than the absolute threshold. According to such a configuration, in the case in which the beam having good reception quality and the beam having poor reception quality coexist, the measurement report including measResults for the unstable NR cells emitting these beams is transmitted, and it is possible to reduce the possibility that the unstable NR cell is selected as the target cell for handover and the mobility success rate is improved.

Here, in the case in which the UE 200 is an unmanned aerial vehicle (UAV), the visibility of the propagation environment is good, and the possibility that the beam having good reception quality and the beam having poor reception quality coexist is increased. Thus, the embodiments are useful in the case in which the UE 200 is an unmanned aerial vehicle (UAV). However, even if the UE 200 is not an unmanned aerial vehicle (UAV), the same situation may occur in the case in which the UE 200 exists on a higher floor, and therefore the UE 200 is not limited to the unmanned aerial vehicle (VIN).

### [Modification 3]

Hereinafter, Modification 2 of the embodiment will be described. Differences from the embodiment will be described below.

In an embodiment, the reception quality of the NR cell may be an average value of the reception qualities of the observed beams. On the other hand, in Modification 3, the reception quality of the NR cell may be the median value of the reception qualities of the observed beams. The NR cell may be a serving cell or a neighboring cell. For example, when the NR cell is a neighboring cell, the above-described Events A3 to A5 and the above-described Events A3* to A5* may be rewritten as follows.

(i) Event A3**

Event A3 is rewritten to define the entry condition of Event A3** as: Neighbour becomes amount of offset better than PCell/PSCell, the neighbour is calculated by median value of beams' qualities of the cell. That is, the reception quality of the neighboring cell compared with the serving cell (PCell/PSCell) in Event A3 is calculated by the median value of the beams.

Alternatively, the entry condition of Event A3* is rewritten to define the entry condition of Event A3* as: Neighbour becomes amount of offset better than Pcell/PSCell and median value of beams' qualities of neighbour is better than absolute thresholdX2. That is, the reception quality of neighboring cells compared with the absolute threshold. (absolute thresholdX2) in Event A3* is calculated by the median value of the beams.

(ii) Event A4**

Event A4 is rewritten to define the entering condition of Event A4** as: Neighbour becomes better than absolute threshold, the neighbour is calculated by median value of beams' qualities of the cell. That is, the reception quality of neighboring cells compared with the absolute threshold (absolute threshold) in Event A4 is calculated by the median value of the beams.

Alternatively, the entering condition of Event A4* is rewritten to define the entering condition of Event A4** as: Neighbour becomes better than absolute threshold and median value of beams' qualities of neighbour is better than absolute threshold Y2. That is, the reception quality of neighboring cells compared with the absolute threshold (absolute thresholdY2) in Event A4* is calculated by the median value of the beams.

(iii) Event A5**

Event A5 is rewritten to define the entering condition of Event A5** as: PCell/PSCell becomes worse than absolute threshold1 AND Neighbour becomes better than another absolute threshold2, the neighbour is calculated by median value of beams' qualities of the cell. The reception quality of neighboring cells compared with the absolute threshold (another absolute threshold2) in Event A5 is calculated by the median value of the beams.

Alternatively, the entering condition of Event A5* is rewritten to define the entering condition of Event A5** as: PCell/PSCell becomes worse than absolute threshold1 AND Neighbour becomes better than another absolute threshold2, and median value of beams' qualities of neighbour is better than absolute thresholdZ2. That is, the reception quality of neighboring cells compared with the absolute threshold (absolute thresholdZ2) in Event A5* is calculated by the median value of the beams.

According to such a configuration, similar to the embodiment, it is possible to suppress the situation in which the measurement report regarding the NR cell is frequently transmitted. Furthermore, as in Modification 2, it is possible to reduce the possibility that the unstable NR cell is selected as the target cell for handover.

### Other Embodiments

Although the contents of the present invention have been described along with the embodiment, the present invention is not limited to these descriptions, and it will be obvious to those skilled in the art that various modifications and improvements can be made thereto.

In the embodiments and the modifications, the case in which the trigger condition used for determining whether to perform measurement reporting is a condition (for example, an entering condition) for starting measurement reporting has been mainly described. However, the embodiment is not limited thereto. The trigger condition may be a condition for ending measurement reporting (for example, a leaving condition). In such a case, the trigger condition may include a condition that the total number of beams observed as beams from neighboring cells is below a threshold.

In Modification 3, the case in which the reception quality of the neighboring cell is calculated by the median value of the beams has been mainly described. However, Modification 3 is not limited thereto. The reception quality of the serving cell may be calculated by the median value of the beams.

The block configuration diagram (FIG. 3) used to describe the above-described embodiment illustrates a block of functional unit. Those functional blocks (structural components) can be realized by a desired combination of at least one of hardware and software. A realization method for each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. For example, a functional block (structural component) that causes transmitting may be called a transmitting unit or a transmitter. For any of the above, as explained above, the realization method is not particularly limited to any one method.

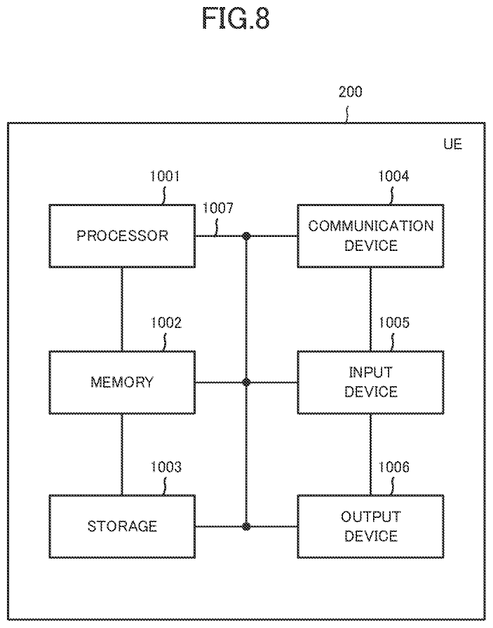

Furthermore, the eNB 111, the gNB 121, and the UE 200 (the device) explained above can function as a computer that performs the processing of the radio communication method of the present disclosure. FIG. 8 is a diagram illustrating an example of a hardware configuration of the device. As illustrated in FIG. 8, the device can be configured as a computer device including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. Hardware configuration of the device can be constituted by including one or plurality of the devices illustrated in the figure, or can be constituted by without including a part of the devices.

The functional blocks of the device (see FIG. 3) can be realized by any of hardware elements of the computer device or a combination of the hardware elements.

Moreover, the processor 1001 performs computing by loading a predetermined software (program) on hardware such as the processor 1001 and the memory 1002, and realizes various functions of the device by controlling communication via the communication device 1004, and controlling reading and/or writing of data on the memory 1002 and the storage 1003.

The processor 1001, for example, operates an operating system to control the entire computer. The processor 1001 can be configured with a central processing unit (CPU) including an interface with a peripheral device, a control device, a computing device, a register, and the like.

Moreover, the processor 1001 reads a program (program code), a software module, data, and the like from the storage 1003 and/or the communication device 1004 into the memory 1002, and executes various processes according to the data. As the program, a program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAI), and the like. The memory 1002 can be called register, cache, main memory (main storage device), and the like. The memory 1002 can store therein a program (program codes), software modules, and the like that can execute the method according to the embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device.

The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

In addition, the respective devices, such as the processor 1001 and the memory 1002, are connected to each other with the bus 1007 for communicating information thereamong. The bus 1007 may be configured by using a single bus or may be configured by using different buses for each device.

Further, the device is configured to include hardware such as a microprocessor, a digital signal processor (Digital Signal Processor: DSP), Application Specific Integrated Circuit (ASIC), Programmable Logic Device (PLD), and Field Programmable Gate Array (FPGA). Some or all of these functional blocks may be realized by the hardware. For example, the processor 1001 may be implemented by using at least one of these hardware.

Notification of information is not limited to that explained in the above aspect/embodiment, and may be performed by using a different method. For example, the notification of information may be performed by physical layer signaling (for example, Downlink Control Information (DCI), Uplink Control Information (UCI), upper layer signaling (for example, RRC signaling, Medium Access Control (MAC) signaling, notification information (Master Information Block (MIB), System Information Block (SIB)), other signals, or a combination of these. The RRC signaling may be called RRC message, for example, or can be RRC Connection Setup message, RRC Connection Reconfiguration message, or the like.

Each aspect/embodiment described in the present disclosure may be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (registered trademark), GSM (registered trademark), CDMA2000, Ultra Mobile Broadband (UM B), IEEE 802.11 (Wi-Fi (registered trademark)), IEEE 802.16 (WiMAX (registered trademark)), IEEE 802.20, Ultra-WideBand (UWB), Bluetooth (registered trademark), systems using other appropriate systems, and next-generation systems extended based on these. Further, a plurality of systems may be combined (for example, a combination of at least one of the LTE and the LTE-A with the 5G).

As long as there is no inconsistency, the order of sequences, flowcharts, and the like of the above-described embodiment may be exchanged. For example, the various steps and the sequence of the steps of the methods explained above are exemplary and are not limited to the specific order mentioned above.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information and signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each aspect/embodiment described in the present disclosure may be used separately or in combination, or may be switched in accordance with the execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of a channel and a symbol may be a signal. (signaling). Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS)”, “radio base station”. “fixed station”, “NodeB”. “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS)”, “user terminal”, “user equipment (User Equipment: UE)”, “terminal” and the like can be used interchangeably.

The mobile station is called by those skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The moving body may be a vehicle (for example, a car, an airplane, or the like), a moving body that moves unmanned (for example, a drone, an automatically driven vehicle, or the like), a robot (manned type or unmanned type). Note that at least one of a base station and a mobile station can be a device that does not necessarily move during the communication operation. For example, at least one of a base station and a mobile station may be an Internet of Things (IoT) device such as a sensor.

Also, a base station in the present disclosure may be read as a mobile station (user terminal, hereinafter the same). For example, each of the aspects/embodiments of the present disclosure may be applied to a configuration that allows a communication between a base station and a mobile station to be replaced with a communication between a plurality of mobile stations (for example, may be referred to as Device-to-Device (D2D), Vehicle-to-Everything (V2X), or the like). In this case, the mobile station may have the function of the base station. Words such as “uplink” and “downlink” may also be replaced with wording corresponding to inter-terminal communication (for example, “side”). For example, terms an uplink channel, a downlink channel, or the like may be read as a side channel.

Likewise, a mobile station in the present disclosure may be read as a base station. In this case, the base station may have the function of the mobile station.

The radio frame may include one or more frames in the time domain. Each of one or more frames in the time domain may be referred to as a subframe.

The subframe may also include one or more slots in the time domain. The subframe may have a fixed time length (for example, 1 ms) that does not depend on numerology.

The numerology may be a communication parameter applied to transmission and/or reception of a certain signal or channel. The numerology may indicate, for example, at least one of subcarrier spacing (SCS), bandwidth, symbol length, cyclic prefix length, transmission time interval (TTI), number of symbols per TTI, radio frame configuration, specific filtering processing performed by the transceiver in the frequency domain, and specific windowing processing performed by the transceiver in the time domain.

The slot may include one or more symbols (Orthogonal Frequency Division Multiplexing (OFDM) symbols, Single Carrier Frequency Division Multiple Access (SC-FDMA) symbols or the like) in the time domain. The slot may be the time unit based on the numerology.

The slot may include a plurality of minislots. Each minislot may include one or more symbols in the time domain. The minislot may also be called a subslot. The minislot may include fewer symbols than the slot. The PDSCH (or PUSCH) transmitted in the time unit larger than the minislot may be called PDSCH (or PUSCH) mapping type A. The PDSCH (or PUSCH) transmitted by using the minislot may be called PDSCH (or PUSCH) mapping type B.

The radio frame, the subframe, the slot, the minislot, and the symbol all represent the time unit for signal transmission. The radio frame, the subframe, the slot, the minislot, and the symbol may have different names corresponding thereto.

For example, one subframe may be called the transmission time interval (TTI), the plurality of consecutive subframes may be called the TTI, and one slot or one minislot may be called the TTI. That is, at least one of the subframe and the TTI may be a subframe (1 ms) in the existing LTE, may be shorter than 1 ns (for example, 1-13 symbols), and may be longer than 1 ms. It should be noted that the unit indicating the TTI may be referred to as the slot, the minislot, or the like, instead of the subframe.

Here, the TTI refers to, for example, the minimum time unit of scheduling in the radio communication. For example, in the LTE system, the base station performs scheduling for allocating radio resources (frequency band width usable in each UE, transmission power, or the like) to each UE in the units of TTI The definition of the TTI is not limited thereto.

The TTI may be a transmission time unit of a channel-encoded data packet (transport block), a code block, a codeword, or the like, or may be a processing unit such as scheduling or link adaptation. It should be noted that, when the TTI is given, the time interval. (for example, the number of symbols) in which the transport block, code block, codeword, or the like are actually mapped may be shorter than that of the TTI.

It should be noted that, when one slot or one minislot is called the TTI, one or more TTIs (that is, one or more slots or one or more minislots) may be the minimum time unit of scheduling. Also, the number of slots (number of minislots) that constitutes the minimum time unit of the scheduling may be controlled.

The TTI having a time length of 1 is may be called normal TTI (TTI in LTE Rel. 8-12), normal TTI, long TTI, normal subframe, normal subframe, long subframe, slot, or the like. The TTI that is shorter than the normal TTI may be called shortened TTI, short TTI, partial TTI (or fractional TTI), shortened subframe, short subframe, minislot, subslot, slot, or the like.

It should be noted that long TTI (for example, normal TTI, subframe, or the like) may be replaced with a TTI having a time length exceeding 1 ms, and the short TTI (for example, shortened TTI) may be read as a TTI having a TTI length that is less than the long TTI length and greater than or equal to 1 ms.

The resource block (RB) is a resource allocation unit in the time domain and the frequency domain, and may include one or more consecutive subcarriers in the frequency domain. The number of subcarriers included in the RB may be the same regardless of the numerology and may be, for example, 12. The number of subcarriers included in the RB may be determined based on the numerology.

Also, the time domain of the RB may include one or more symbols and may have a length of one slot, one minislot, one subframe, or one TTI. One TTI, one subframe, or the like may include one or more resource blocks.

It should be noted that one or more RBs may be called a physical resource block (Physical RB: PRB), a subcarrier group (Sub-Carrier Group: SCG), a resource element group (Resource Element Group: REG), a PRB pair, an RB pair, or the like.

Also, the resource block may include one or more resource elements (Resource Element: RE). For example, one RE may be a radio resource area of one subcarrier and one symbol.

The bandwidth part (BWP) (which may also be called partial bandwidth) may indicate a subset of continuous common RBs (common resource blocks) for a certain numerology in a certain carrier. Here, the common RB may be specified by the index of the RB based on the common reference point of the carrier. The PRB may be defined in the BWP and may be numbered in the BWP.

The BWP may include a BWP for UL (UL BWP) and a BWP for DL (DL BWP). One or more BWPs may be configured in one carrier for the UE.

At least one of the configured BWPs may be active, and the UE may not expect to transmit or receive certain signals/channels outside the active BWP. It should be noted that “cell”. “carrier”, or the like in the present disclosure may be read as “BWP”.

The structures of the radio frame, the subframe, the slot, the minislot, the symbol, and the like described above are merely examples. For example, the configurations such as the number of subframes included in the radio frame, the number of slots per subframe or radio frame, the number of minislots included in the slot, the number of symbols and RBs included in the slot or minislot, the number of subcarriers included in the RB, and the number of symbols in the TTI, the symbol length, and the cyclic prefix (CP) length can be variously changed.

The terms “connected”, “coupled”, or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access”. In the present disclosure, two elements can be “connected” or “coupled.” to each other by using one or more wires, cables, printed electrical connections, and as some non-limiting and non-exhaustive examples, by using electromagnetic energy having wavelengths in the radio frequency region, the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on”.

The “means” in the configuration of each device may be replaced with “means”, “circuit”, “device”, and the like.

Any reference to an element using a designation such as “first”, “second”, and the like used in the present specification generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present specification or the claims is intended not to be an exclusive disjunction.

Throughout this disclosure, for example, during translation, if articles such as “a”, “an”, and “the” in English are added, in this disclosure, these articles shall include plurality of nouns following these articles.

The term “deciding” and “determining” as used in the present disclosure may encompass various operations. The “deciding” and the “determining” may include, for example, “deciding” or “determining” of judging, calculating, computing, processing, deriving, investigating, looking up, search, inquiry (for example, searching in a table, a database, or another data structure), ascertaining, and the like. Also, the “deciding” and the “determining” may include “deciding” and “determining” of receiving (for example, receiving information), transmitting (for example, transmitting information), input, output, accessing (for example, access to data in the memory), and the like. Also, the “deciding” and the “determining” may include “deciding” and “determining” of resolving, selecting, choosing, establishing, comparing, and the like. That is, the “deciding” and the “determining” may include “deciding” and “determining” of operations. Also, the “deciding (determining)” may be read as “assuming”, “expecting”, “considering,” and the like.

In the present disclosure, the term “A and B are different” may mean “A and B are different from each other”. It should be noted that the term may mean “A and B are each different from C”. Terms such as “leave”, “coupled”, or the like may also be interpreted in the same manner as “different”.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

100 Radio communication system
110 E-UTRAN
111 eNB
120 NG RAN
121 gNB121
200 UE
210 Receiving unit
220 Measuring unit
230 Transmitting unit
240 Control unit
1001 Processor
1002 Memory
1003 Storage
1004 Communication device
1005 Input device
1006 Output device
1007 Bus
C11 to C13 Cell
C21 to C23 Cell
P40 Serving cell
N50(N51, N52)Neighboring cell
N60(N61 to N63) Neighboring cell

1. A terminal comprising:
a transmitting unit configured to transmit, to a radio access network, a measurement report including reception qualities regarding cells including a serving cell and neighboring cells; and
a control unit configured to determine whether a trigger condition used for determining whether to perform a procedure of transmitting the measurement report is satisfied,
wherein the trigger condition includes at least a condition regarding individual beams from the cells.

2. The terminal according to claim 1, wherein the trigger condition includes a condition that a total number of beams observed as beams from the neighboring cells exceeds a threshold.

3. The terminal according to claim 1, wherein the trigger condition includes a condition that a total number of beams having a reception quality of the serving cell or a reception quality better than an absolute threshold in the beams observed as the beams from the neighboring cells exceeds a threshold.

4. The terminal according to claim 1, wherein the trigger condition includes a condition that a reception quality of a beam observed as a beam from the neighboring cell is better than a reception quality of the serving cell or an absolute threshold.

5. A measurement report transmission method comprising:
a step of transmitting, from a terminal to a radio access network, a measurement report including reception qualities regarding cells including a serving cell and neighboring cells; and
a step of determining, by the terminal, whether a trigger condition used for determining whether to perform a procedure of transmitting the measurement report is satisfied,
wherein the trigger condition includes at least a condition regarding individual beams from the cells.

6. The terminal according to claim 2, wherein the trigger condition includes a condition that a total number of beams having a reception quality of the serving cell or a reception quality better than an absolute threshold in the beams observed as the beams from the neighboring cells exceeds a threshold.
